(19) United States
(12) Patent Application Publication
(10) Pub. No.: US 2013/0068640 A1
(43) Pub. Date: Mar. 21, 2013

(54) CLEANING KIT FOR STROLLER

(71) Applicant: BUGGY LOVE, LCC, Las Vegas, NV (US)

(72) Inventors: Kristin McLellan, Ridgewood, NJ (US); Jonathan McLellan, Ridgewood, NJ (US); Craig Palmer, Irvine, CA (US); Kimberly Palmer, Irvine, CA (US)

(73) Assignee: BUGGY LOVE, LLC, Las Vegas, NV (US)

(21) Appl. No.: 13/624,670

(22) Filed: Sep. 21, 2012

Related U.S. Application Data
(60) Provisional application No. 61/537,341, filed on Sep. 21, 2011.

(51) Int. Cl. B62B 9/00; B65D 77/00

(52) U.S. Cl. 206/229; 206/216; 224/409; 206/233

(57) ABSTRACT

An organic stroller cleaning kit is provided and includes various cleaning products that are formed of all-natural ingredients and therefore, are infant and child friendly.

### CROSS REFERENCE TO RELATED APPLICATION

The present application claims priority to U.S. patent application Ser. No. 61/537,341, filed Sep. 21, 2011, which is hereby incorporated by reference in its entirety.

### TECHNICAL FIELD

The present invention relates in general to strollers and in particular, relates to an organic cleaning kit for cleaning and maintaining the various components of a traditional stroller.

### BACKGROUND

Traditionally, baby strollers have been used to push an infant slowly on a relatively hard, smooth floor or sidewalk. However, over the years, all-terrain baby strollers became popular and this type of stroller typically employs much larger wheels, similar to small bicycle tires. The stroller frame members are also constructed to be more robust. Other types of strollers have also come on the market.

While there are many accessories of the market for strollers, including sun, wind and rain shields and cup holders and storage holders, etc., there is a lack of specially designed cleaners that are designed to be used with strollers. As is well known, like vehicles, strollers are exposed to the elements and dirt and grime that are found on sidewalks and streets and therefore, the stroller parts require periodic cleaning in order to maintain a pleasing look and also to maintain proper working condition. Many parents use conventional all-purpose household cleaners to clean the stroller including surfaces which are in direct contact with the infant or child. These conventional household cleaners contain harsh chemicals, etc., and therefore, they are ill suited for applications that expose infants and young children to the chemicals.

As strollers become more and more fashionable and there is an ever increasing organic (all-natural), eco-friendly movement, there is a need for a stroller cleaning accessory that offers an attractive, environmentally friendly cleaning product and at the same time permits the user to maintain a level of fashion.

### SUMMARY

An organic stroller cleaning kit is provided and includes various cleaning products that are formed of all-natural ingredients and therefore, are infant and child friendly.

These and other aspects and features of the invention can be appreciated from the accompanying drawing figures and detailed description of certain embodiments.

### BRIEF DESCRIPTION OF DRAWING FIGURES

FIG. 1 is a perspective view of a stroller cleaning kit in accordance with the present invention in both open and closed positions;

FIG. 2 is a perspective view of the stroller cleaning kit in an open position;

FIG. 3 is a perspective view of the stroller kit in an open position and according to another embodiment;

FIG. 4 is a perspective view of a dispenser for wipes according to one embodiment;

FIG. 5 is a perspective view of a fluid dispenser according to one embodiment;

FIG. 6 is a perspective view of a fluid dispenser according to another embodiment; and

FIG. 7 is a perspective view of a cleaning accessory according to one embodiment.

### DETAILED DESCRIPTION OF CERTAIN EMBODIMENTS

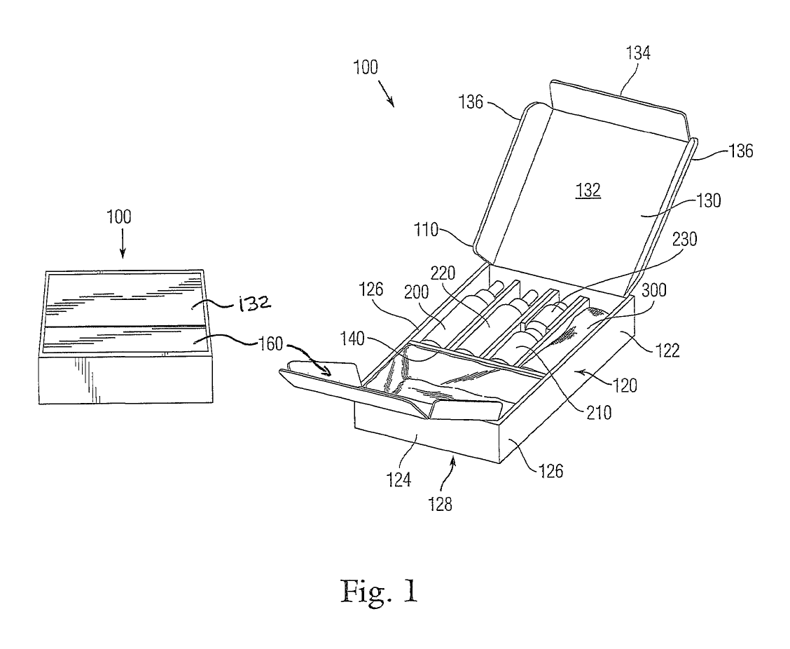

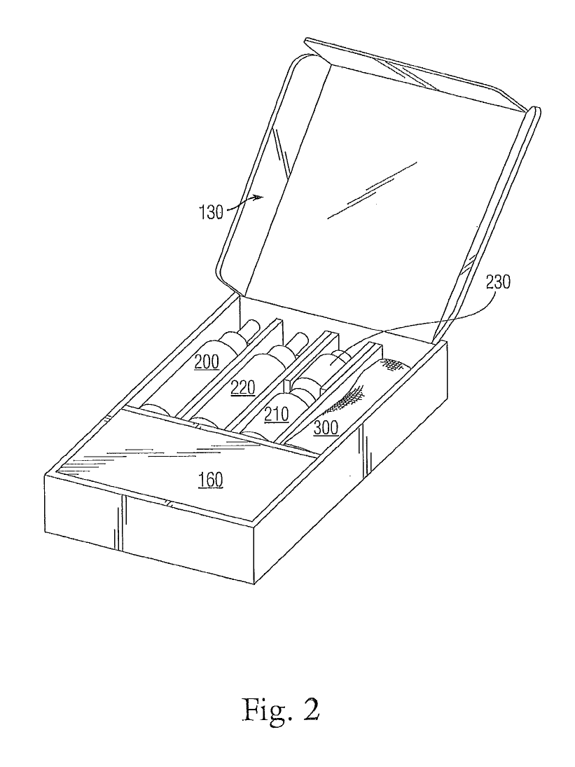

FIGS. 1-2 illustrate a kit 100 that is intended to clean various components (parts) of a typical stroller. As is known, a traditional stroller includes a frame including a handle; a seat; wheels, and typically some type of storage compartment.

The kit 100 includes a number of individual products that are designed to clean and refresh the appearance of the stroller and also maintain the operative components of a stroller.

In yet another aspect of the present invention, the individual products that are part of the kit 100 are made from organic and all-natural ingredients.

The kit 100 includes packaging 110 that attractively contains all of the organic products that are part of the kit 100 and allows the kit components to be easily transported, such as being transported in the stroller itself. In the illustrated embodiment, the packaging 110 is in the form of a box that includes a base portion 120 and a closeable cover portion 130. The base portion 120 is defined by a top wall 122, an opposite bottom wall 124, opposing side walls 126, and a floor 128. The cover portion 130 is attached along the top wall 122 of the base portion 120 and includes a center section 132, a bottom flap 134 and two side flaps 136. To close the box 110, the flaps 134, 136 are received within the walls of the base portion 120.

Within the base portion 120, dividers 140 and the like are provided for further dividing the hollow interior of the base portion 120 into discrete compartments that receive and hold one or more of the products.

In the illustrated embodiment, the base portion 120 can include a top flap 160 that is located along and extends from the bottom wall 124. The top flap 160 is intended to be positioned substantially parallel to the floor 125. When the cover 130 is closed, the bottom flap 134 seats against and is adjacent the top flap 160. As shown in FIG. 1, in a closed position, the center section 132 and the flap 160 lie in substantially the same plane and define a front of the packaging.

The individual products contained within the packaging 110 provide, as mentioned above, organic cleaners that are each intended to perform a specific cleaning or other related operation relative to the stroller. It will be understood that the individual organic products are themselves packaged in receptacles, such as bottles or the like. In the illustrated embodiment, the liquid organic products are contained in bottles.

In the illustrated embodiment, there is a first organic product 200, a second organic product 210, a third organic product 220, and a fourth organic product 230.

The first organic product 200 is a refreshing spray product that is intended to sprayed over the stroller components to provide a pleasing re-freshening experience. The first organic product 200 is a liquid formed of organic/all-natural ingredients. For example, the first organic product 200 is in the form of a delicious and pure organic rosehip scented spray for all over re-freshening. A conventional sprayer can be part of the bottle or other dispensing (squirt) means can be used. The first organic product 200 is marketed by the present applicant under the name FreshLOVE.

The second organic product 210 is an all purpose cleaner that is intended to be sprayed over the stroller components for cleaning thereof. The second organic product 210 is a liquid formed of organic/all-natural ingredients. For example, the second organic product 210 is in the form of a zesty and refreshing, organic clementine cleaner for universal use on all stroller surfaces. A conventional sprayer can be part of the bottle or other dispensing (squirt) means can be used. The second organic product 210 is marketed by the present applicant under the name FabricLOVE.

The third organic product 220 is a stroller frame cleaner/polisher that is intended to be sprayed over the stroller frame for cleaning and polishing thereof. The third organic product 220 is a liquid formed of organic/all-natural ingredients. For example, the third organic product 220 is in the form of a tangy and crisp, organic tangerine scented spray for cleaning dirt and grime from stroller frames. A conventional sprayer can be part of the bottle or other dispensing (squirt) means can be used. The third organic product 220 is marketed by the present applicant under the name PolishLOVE.

The fourth organic product 230 is an all natural wheel lube that eliminates squeaks and squeals from the stroller's wheels. The fourth organic product 230 is marketed by the present applicant under the name WheelLOVE.

It will be appreciated that the individual volume of the liquid products can be varied and the precise locations of the products in the packaging 110 can also vary. In the illustrated embodiment, the larger volume products, namely, the products 200, 220 each occupies a single compartment, while the products 210, 230 share a single discrete compartment.

By using only organic, all-natural products, the infant/child is not exposed to the harsh chemicals that are found in all-purpose household cleaners that are being used by parents to clean the stroller components.

The kit 100 also includes a number of other components that complement the liquid organic products. For example, a microcloth 300 can be provided and disposed within one of the discrete compartments in the box 110. The microcloth is a re-usable, durable, washable, reclaimed microfiber cloth for general cleaning and can be marketed under the name MicroLOVE. In addition a scrub brush can be provided as a complement to the fourth organic cleaner 230 to allow a user to scrub clean the wheels of the stroller. The brush is marketed under the name LOVE scrub brush.

In addition, to permit a user to remove the kit components and transport them to another location using the stroller a re-usable drawstring carrying bag (e.g., cotton bag) can be provided. The bag is sized to allow all of the components of the kit 100 to be carried therein and placed under the stroller in case of a messy emergency. This component is marketed under the name Bag O′LOVE.

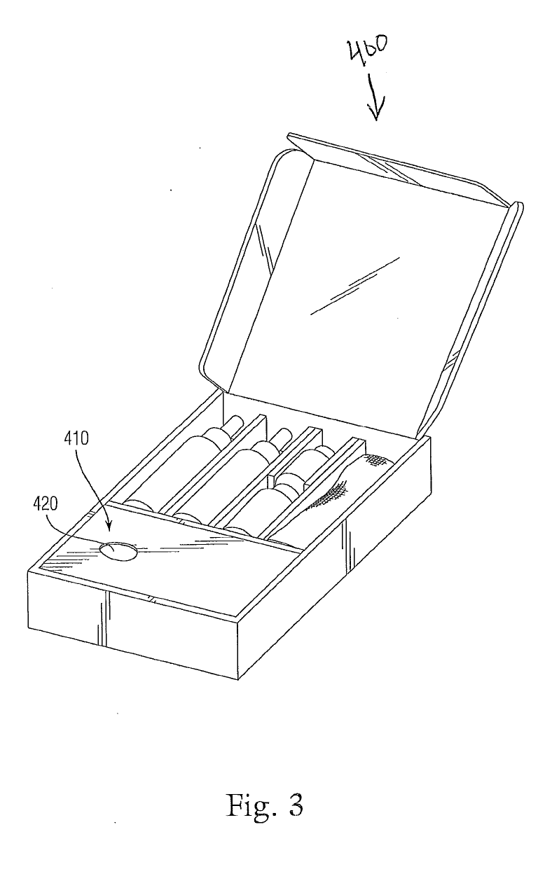

As shown in FIG. 3, in another embodiment, a stroller cleaning kit 400 is illustrated and is similar to the kit 100 with the exception that the kit 400 includes an integral waste receptacle 410 to permit a user to place waste, such as dirty wipes or the dirty microtowel. The waste receptacle 410 includes an opening 420 that is accessible to the user. The opening 420 leads into an open interior waste receptacle that can be coated so as to protect against liquids and solids that may be on the waste and permit cleaning thereof. The opening 420 can be sealable. In the illustrated embodiment, the waste receptacle 410 is located below at least some of the discrete compartments and the opening 420 can be formed in the top flap 160.

In addition, adjacent the waste receptacle 410 a towel or wipe dispenser can be provided. The dispenser can be in the form of a cartridge that contains the wipes/towels and allows individual dispensing thereof. While not shown, the portion of the box immediately adjacent and to the right of the waste receptacle 410 can be an open compartment that receives the cartridge—which can be frictionally held therein.

In yet another embodiment, the carrying bag can include an integral fastener to allow the carrying bag to be supported by the frame of the stroller, such as being hung on the frame. The fastener can be in the form of a clip or C-shaped clamp or the like that is formed along or is attached to the drawstring of the carrying bag.

The stroller cleaning kit 100 is marketed by the present applicant under the name BuggyLOVE which is the first-ever, organic stroller cleaning kit. We are proud to say that it is made for parents, by parents. There is no part of our product we wouldn't use on our own child's stroller.

The product is novel and sleek in design, but simple in concept. It is derived from a combination of organic and all-natural ingredients. It was created with the planet in mind and features novelty items that promote re-usability. BuggyLOVE is luxuriously packaged to stand-out to masses yet purposeful and discreet in selection of its contents.

These homes away from home (aka—strollers) are going to require maintenance, love and hard core cleaning. Let's do it with BuggyLOVE.

In yet another aspect, one or more of the product bottles can include an integral clamp, such as a C-shaped clamp, that allows the bottle to be coupled to a frame member of the stroller. For example, the FreshLOVE product can be coupled to the frame by frictionally receiving the frame member (e.g., tubular member) within the C-shaped clamp that is integral to the body of the bottle and extends outwardly therefrom. This allows the product to be always close to the user.

In yet another embodiment, the base portion can include a discrete compartment (e.g., below the discrete compartments that hold the liquid products) that receives a cartridge that holds waste bags and the top flap 160 can be configured to have an opening such as opening 420 that allows dispensing of a waste bag. For example, the waste bags can be used for soiled towels or wipes used during the cleaning of the stroller and also for waste generated during cleaning of the infant or child. To remove the cartridge, the top flap 160 is simply lifted. In this manner, a convenient waste bag dispenser is incorporated into the box 110 that holds the other components.

Features of one embodiment can be used in other embodiments within the scope of the present invention.

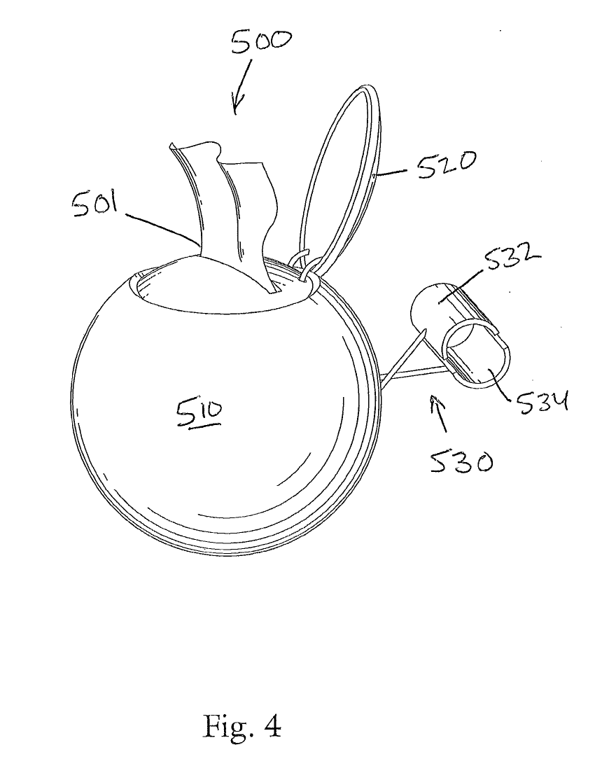

FIG. 4 shows a dispenser 500 according to one embodiment. The dispenser 500 is intended to hold an item, such as wipes 501, that are selectively removed from the dispenser 500 by the user when needed. The dispenser 500 is formed of a body 510 which in the illustrated embodiment has a spherical shape. The body 510 is hollow to hold the wipes 501 which can come as a cartridge or pack, etc. The body 510 includes a pivotable lid or cover 520 that can be opened by the user to provide direct access to the wipes 501.

The dispenser 500 also includes a fastener (coupling member) 530 for attaching the dispenser to another article, such as a stroller (e.g., a handle or frame of the stroller). The fastener 530 can take any number of different forms that allow the dispenser 500 to be securely attached and then detached from the stroller. The illustrated fastener 530 is a clamp structure that has a pair of biased clamp arms 532, 534 that are normally biased to assume a closed position as shown. To open the fastener 530, the clamp arms 532, 534 are separated by overcoming the biasing force. Once opened, the frame member (e.g., handle bar) is received between the arms 532, 534 and the arms are released, thereby clamping the dispenser to the stroller.

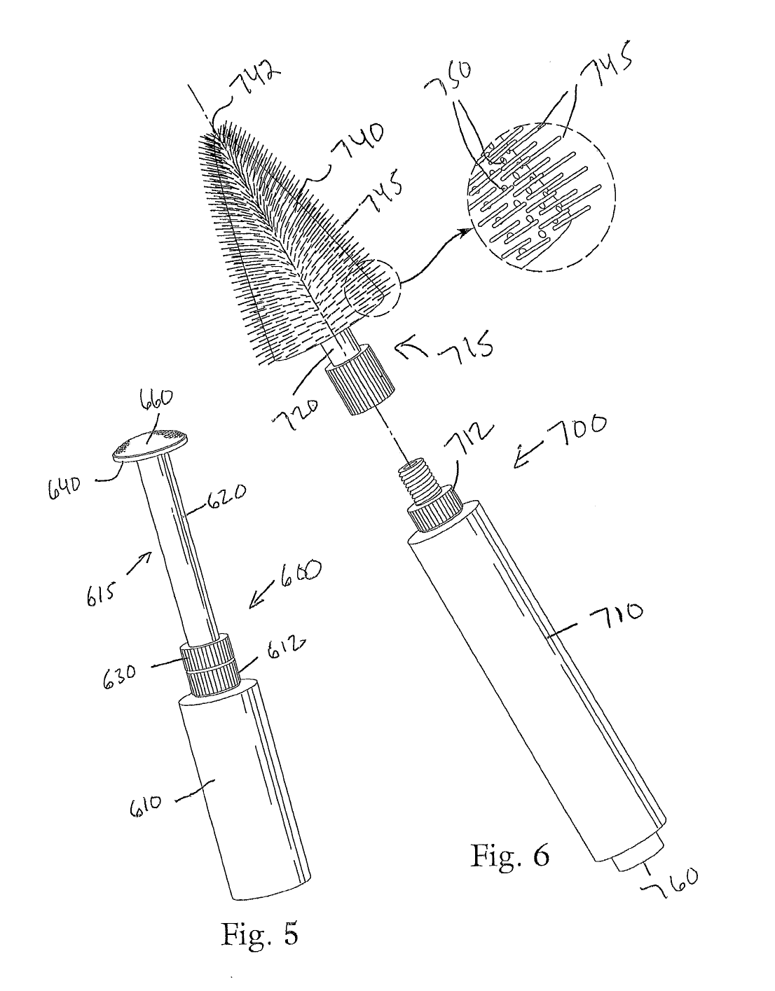

FIG. 5 shows a fluid dispenser 600 for dispensing a fluid, such as a fluid contained in one of the bottles in the kit 100. The dispenser 600 is in the form of a bottle (such as bottles 200-230) 610 that includes an open top end 612. A dispenser accessory 615 is coupled to the end 612 as by threadingly mating the two together. The accessory 615 is in the form of a body 620 that has a connector 630 at one end that attached to a complementary structure at the top end 612 of the bottle (as by mating threads formed on each structure). At an opposite end, the body 620 includes a dispenser head 640 for dispensing fluid that is contained within the bottle 610. The head 640 includes a frame or substrate 650 that carries a fabric patch (microfiber) 660.

It will be appreciated that the length of the body 620 can be varied (e.g., shortened compared as the illustrated embodiment).

The head 640 is in fluid communication with the fluid within the bottle 610 by means of the hollow body 620 such that inversion of the bottle causes fluid to contact and wet the fabric 660 on the head 640. For example, the head 640 can include a number of small discharge ports beneath the fabric 660 which allow the fluid to contact and wet the fabric 660.

Once the fabric 660 is wet, it acts as a cleaning aid and the user can clean an article as by a blotting action. In other words, once the fabric 660 is wet with a cleaning agent, the fabric patch 660 is then placed into contact with an article to be cleaned (i.e., clothing, fabric stroller part, etc.).

FIG. 6 shows a fluid dispenser 700 for dispensing a fluid, such as a fluid contained in one of the bottles in the kit 100. The dispenser 700 is in the form of a bottle (such as bottles 200-230) 710 that includes an open top end 712. A dispenser accessory 715 is coupled to the end 712 as by threadingly mating the two together. The accessory 715 is in the form of a body 720 that has a connector 730 at one end that attached to a complementary structure at the top end 712 of the bottle (as by mating threads formed on each structure). At an opposite end, the body 720 includes a dispenser head 740 for dispensing fluid that is contained within the bottle 710 and for cleaning a surface.

In the illustrated embodiment, the head 740 has a conical shape with a pointed tip 742. The head 740 is constructed such that an exterior surface thereof carries bristles 745 and the head 740 includes a plurality of discharge ports (openings) 750 that are located at selective locations along the cone shape. The discharge ports 750 are in fluid communication with the fluid in the bottle 710 and thus, when the bottle is inverted, fluid can flow therethrough. The discharged fluid in combination with bristles 745 allows cleaning of areas, such as spokes of the wheel or other hard to read areas. The bottle can be a squeeze bottle.

Alternatively, a button 760 can be provided to selectively open the ports 750 to allow fluid discharge.

The dispensers 600 and 700 can be part of the kit 100.

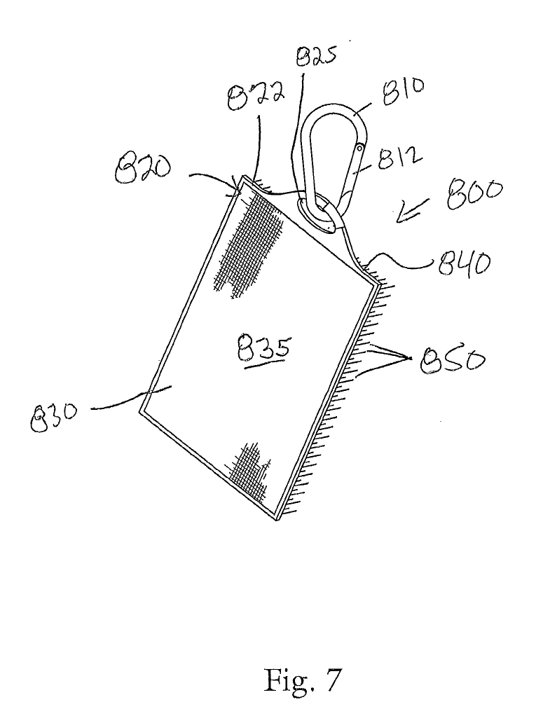

FIG. 7 shows another accessory 800 that can be part of the kit 100. The accessory 800 is another cleaning aid. The accessory 800 includes a fastener 810 in the form of a carabiner that has pivotable gate 812. The carabiner 810 can receive through gate 812 a frame section (e.g., handlebar) of the stroller. The accessory 800 also includes a cleaning substrate 820 that has a first end 822 and an opposite end 824. The first end 822 includes an opening 825 for receiving the carabiner to allow the substrate 820 to be suspended from the carabiner. The substrate (a flexible plastic or a rigid plastic, etc.) 820 includes a first face 830 and an opposite second face 840. The first face 830 includes a fabric (microfiber) 835 that serves as a cleaning surface and the second face 840 includes bristles 850 for cleaning surfaces. Thus, scrubbing can be performed using the accessory 800.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. An organic cleaning kit for a stroller comprising:
a box that includes a base portion with an open interior that is divided into a plurality of discrete compartments, the box having a closeable cover; and
a plurality of organic products intended for application to components of the stroller for cleaning and upkeep thereof, the organic products being formed of all-natural ingredients that are infant and child safe, the organic products being disposed within the discrete compartments of the box.

2. The cleaning kit of claim 1, further comprising:
a scrub brush;
a fabric towel; and
a carrying bag that is closeable by means of a drawstring.

3. The cleaning kit of claim 2, wherein the carrying bag includes a fastener to permit the bag to hung in a supported manner from a frame of the stroller.

4. The cleaning kit of claim 3, wherein the fastener comprises a clip that is associated with the drawstring.

5. The cleaning kit of claim 1, wherein the box includes an integral handle formed on a top wall thereof to permit the box to be hung from a frame of the stroller.

6. The cleaning kit of claim 5, wherein the handle comprises a stamped, perforated portion of the top wall.

7. The cleaning kit of claim 1, wherein the box is formed of recycled organic material.

8. The cleaning kit of claim 1, wherein the organic products include: an organic re-freshening spray; an organic cleaner; an organic polisher; and an organic wheel lube.

9. An organic cleaning kit for a stroller comprising:
a box that includes a base portion with an open interior that is divided into a plurality of discrete compartments, the box having a closeable cover; and
a plurality of organic products intended for application to components of the stroller for cleaning and upkeep thereof, the organic products being formed of all-natural ingredients that are infant and child safe, the organic products being disposed within the discrete compartments of the box;
wherein the box includes a waste receptacle that is constructed in the base portion below at least some of the discrete compartments, the waste receptacle having an opening that occupies an area that is less than an open area of the waste receptacle that stores waste.

10. The cleaning kit of claim 9, wherein the box further includes an integral wipe dispenser that complements the waste receptacle.

11. The cleaning kit of claim 10, wherein the wipe dispenser comprises a cartridge containing wipes that sits within a discrete compartment in the base portion adjacent the waste receptacle.
